(19) United States
(12) Patent Application Publication
(10) Pub. No.: US 2017/0063088 A1
(43) Pub. Date: Mar. 2, 2017

(54) Method for Power Budget

(71) Applicant: MEDIATEK INC., Hsinchu (TW)

(72) Inventors: Wei-Ting Wang, Taipei City (TW); Yingshiuan Pan, Kaohsiung City (TW); Chien-Tse Fang, Taipei City (TW)

(21) Appl. No.: 14/937,576

(22) Filed: Nov. 10, 2015

Related U.S. Application Data
(60) Provisional application No. 62/213,246, filed on Sep. 2, 2015.

(51) Int. Cl. H02J 3/14; G05B 15/02

(52) U.S. Cl. CPC H02J 3/14; G05B 15/02

(57) ABSTRACT

Methods and apparatus are provided for adjusting the power limit based on multiple factors including the current temperature, the previous temperature, and the target temperature. In one novel aspect, the device obtains the total power limit based on the base power and the delta power. The base power is set to be the current power if the temperature-jump is higher than a temperature-jump threshold, otherwise, is set to be the previous power limit. The delta power equals to the weighted conversion sum of the temperature jump and the temperature margin, which is the temperature difference between the current temperature and the target temperature. In another novel aspect, the device calculates one or more component power limit for each corresponding component power source of the device based on the total power limit. The device adjusts power settings for each corresponding component power source based on the component power limit.

### CROSS REFERENCE TO RELATED APPLICATIONS

This application claims priority under 35 U.S.C. §119 from U.S. Provisional Application No. 62/213,246, entitled “METHOD FOR PRECIOUS POWER BUDGET,” filed on Sep. 2, 2015, the subject matter of which is incorporated herein by reference.

### TECHNICAL FIELD

The disclosed embodiments relate generally to power/resource budget method, and, more particularly, to precious power/resource budget.

### BACKGROUND

With the rapid growth in mobile/wireless and other electronics devices, the battery life becomes an important factor in the success of such devices. At the same time, many advanced applications for these devices are becoming more and more popular. Such applications normally require high performance of components in the devices. Sustainable power is limited by the dissipation capability and thermal constraint. The device or semiconductor chips can malfunction if the temperature is too high. Thermal throttle methods are commonly used in the devices to prevent overheat problems due to the dissipation limitation. The traditional thermal throttling unnecessarily sacrifices the performance in order to maintain the temperature with the target temperature. In the traditional way, the device monitors the temperature and triggers power reduction if the temperature becomes higher than a threshold. If the power reduction is too fast, it results in noticeable performance degradation and affects overall device performance. The performance is limited by the sustainable power. If the power reduction is too slow, the temperature continues to rise before it goes down. Overheating will cause shortened lifespan of the chips or even cause permanent damage to the device.

Further, there may be multiple heat sources in the device, together with multiple power sources. Each power source may contribute differently to the temperature rise. Power reductions may result differently both in performance and thermal reduction. A single temperature or power limitation does not adapt to best serve the multiple heat sources problems

Improvements and enhancements are needed for precious power budget for electronic devices.

### SUMMARY

Methods and apparatus are provided for precious power budget to enhance the performance while controlling the temperature under a target temperature. In one novel aspect, the total power limit for the device is adjusted based on multiple factors including the current temperature, the previous temperature, and the target temperature. The power limit is the upper bound of the next available power setting. In one embodiment, the device monitors and obtains sampling temperatures including the current temperature and the previous temperature. The device detects one or more temperature triggering events and generates a total power limit based on the current temperature, the previous temperature, and a target temperature upon detecting one or more temperature triggering events. In one embodiment, the device calculates the temperature jump, which is the temperature difference between the current temperature and the previous temperature, and the temperature margin, which is the temperature difference between the current temperature and the target temperature. The device triggers power adjustment upon detecting the temperature jump is greater than a temperature-jump threshold and/or the temperature margin is smaller than a temperature margin threshold. The power adjustment can be triggered by any combination of triggering events based on the temperature jump and the temperature margin.

In one novel aspect, the total temperature power limit is determined by the base power and the delta power limit. In one embodiment, the delta power limit is determined by the weighted sum of the temperature jump and the temperature margin. The base power is set to be or according to the current power if the temperature jump is greater than a temperature-jump threshold or the temperature margin is smaller than a temperature-margin threshold. The base power is set to be the previous power limit if the temperature jump is smaller than or equals to a temperature-jump threshold. In one embodiment, the total temperature power limit equals to the sum of the base power and the delta power limit.

In another novel aspect, the device calculates one or more component power limit for each corresponding component power source of the device based on the total power limit. The device adjusts power setting for each corresponding component power source based on the component power limit.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 shows simplified block diagrams of a device that performs precious power budget in accordance with embodiments of the current invention.

FIG. 2 illustrates an exemplary chart of power adjustment based on the temperature jump and temperature margin in accordance with embodiments of the current invention.

FIG. 3 shows an exemplary block diagram of adjusting the power setting based on multiple factors include the current temperature, the previous temperature and the target temperature in accordance with embodiments of the current invention.

FIG. 4 shows an exemplary flow chart of generating a total power-limit based on multiple temperature inputs and temperature settings in accordance with embodiments of the current invention.

FIG. 5 illustrates comparison graphs of power adjustment based on traditional power throttling verses using the precious power budget methods in accordance with embodiments of the current invention.

FIG. 6 illustrates exemplary power lookup table for different processors in accordance with embodiments of the current invention.

FIG. 7 shows an exemplary flow chart of the precious power budget procedure to maximize the performance in accordance with embodiments of the current invention.

### DETAILED DESCRIPTION

Reference will now be made in detail to some embodiments of the invention, examples of which are illustrated in the accompanying drawings.

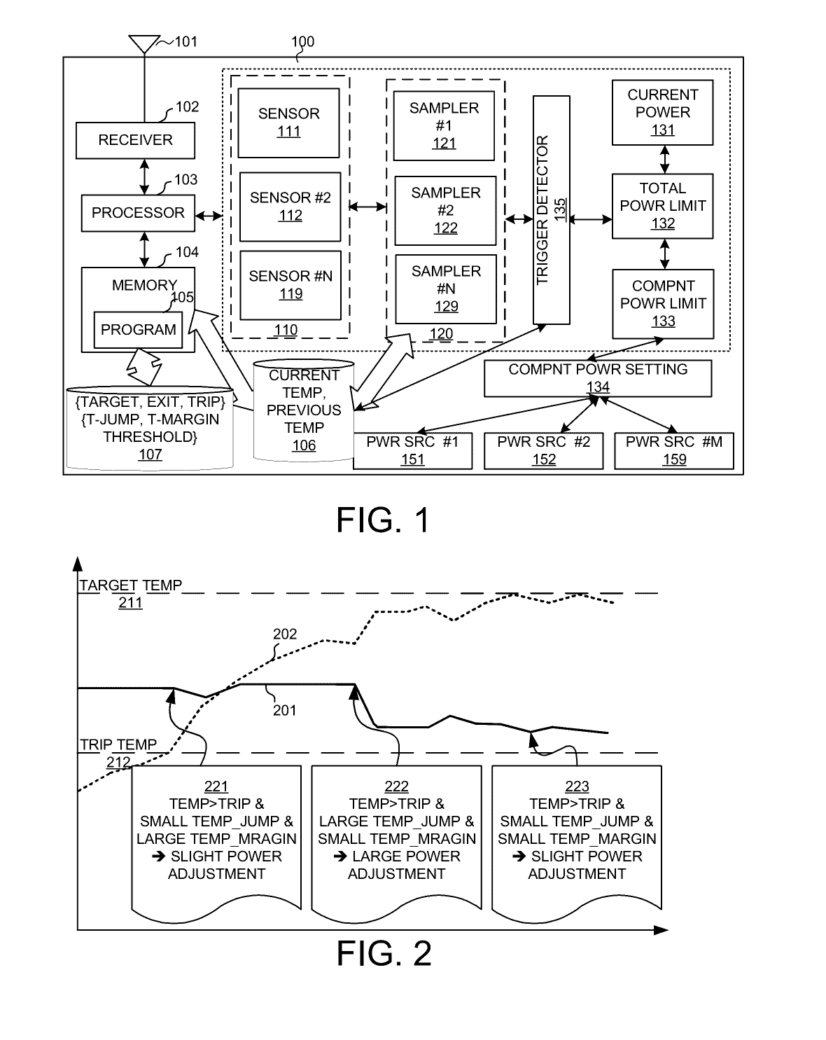

FIG. 1 shows simplified block diagrams of a device 100 that performs precious power budget in accordance with embodiments of the current invention. Device 100 has an optional antenna 101 that receives wireless radio signals. A receiver module 102, optionally coupled with the antenna, receives RF signals from antenna 101, converts them to baseband signals and sends them to processor 103. Processor 103 processes the received baseband signals and invokes different functional modules to perform features in device 100. Memory 104 stores program instructions and data to control the operations of device 100. One or more databases are stored in memory 104. Device 100 includes one or more power sources, such as a power source #1 151, a power source #2 152, and a power source #M 159. In one embodiment, each power source is controlled with corresponding power limit. The power setting of each power source is adjusted based on its corresponding power limit.

In one embodiment, one or more database, such as database 106 and database 107 may reside in memory 104, or in a hard disk inside device 100. Further, database 106 and/or database 107 may also reside in other forms of memory external to device 100. Database 106 stores one or more sets of the current temperature and the previous temperature. Database 107 stores predefined or preconfigured parameters such as the target temperature, the trip temperature, and the exit temperature. In general, the trip temperature and the exit temperature are smaller than the target temperature. The trip temperature is higher than or equals to the exit temperature. Database 107 also stores preconfigured or predefined thresholds, such the temperature-jump threshold and the temperature margin threshold. The target temperature is an upper temperature limit for the device to operate. The trip temperature is a temperature threshold that triggers the reduction of the power setting if the current temperature is higher than the trip temperature. In some embodiments, the exit temperature is a temperature threshold that triggers the restore of the power setting if the current temperature is lower than the exit temperature. In some other embodiments, the exit temperature is a temperature threshold that stops adjusting the power setting if the current temperature is lower than the exit temperature. In such condition, the power budget may be further set to unlimited. In another embodiment, database 106 and database 107 can be combined into one database or any other form of combination.

Device 100 also includes a set of control modules, such as sensors 110, temperature samplers 120, a current power detector 131, a total power limit unit 132, a component power-limit unit 133, a component power-setting unit 134, and a trigger detector unit 135. Sensors 110 includes one or more sensors, such as sensor #1 111, sensor #2 112, and sensor #N 119. In one embodiment, each sensor corresponds to a temperature sampler, such as sampler #1 121, sampler #2 122, and sampler #N 129. In one embodiment, the sensor and the sampler can reside in one module/unit.

In one novel aspect, a total power limit is dynamically calculated based on the previous temperature, the current temperature, and the target temperature. In one embodiment, total power limit unit 132 obtains one or more sets of the current temperature and the previous temperature from database 106. Total power limit unit 132 generates a total power limit based on the current temperature, the previous temperature, and a target temperature upon detecting one or more temperature triggering events. Total power limit unit 132 calculates a temperature jump, which is the difference between the current temperature and the previous temperature, and temperature margin, which the distance from the current temperature to the target temperature.

Current power unit 131 obtains the current power. In one embodiment, current power unit 131 obtains the current power using table lookup. The current power table includes the Operating Performance Point (OPP), the value of the power, the performance data, any other power related information or combination thereof. In another embodiment, current power unit 131 uses software formula to get the current power using input parameters such as the number of running cores of the power source, the running frequency, the loading, any other power related parameter or combination thereof. In yet another embodiment, current power unit 131 relies on hardware power meter to obtain the current power. Current power unit 131 may use any combination of the methods for different power sources. In one embodiment, current power unit 131 may calculate a total power based on each power reading from different power sources.

In another novel aspect, corresponding power limit for each power source is generated based on the total power limit generated by total power limit 132. Component power-limit unit 133 generates power limit for each corresponding power component in the device based on the total power limit. Component power setting unit 134 determines component power settings for each corresponding component based on the corresponding component power limit. Component power setting unit 134 adjusts corresponding power settings for each power source based on the component power settings. Trigger detector 135 detects one or more temperature triggering events. In one embodiment, the temperature triggering events includes the events that the current temperature is higher than a trip temperature and the current temperature is lower than an exit temperature. In another embodiment, the trigger events include the events that the temperature jump is higher than the temperature-jump threshold, and the temperature margin is lower than the temperature-margin threshold.

To maintain the temperature of the device below a target temperature, the power setting of the heat source needs to be adjusted. When the power setting is adjusted to a lower level, the performance is reduced. Therefore, dynamic algorithms are needed to enhance the performance while maintaining the temperature to be within the limit. In a traditional way, a power limit is used to reduce the power setting once the temperature is over a threshold. Such method unnecessarily sacrifices performance if the configuration adjusting the power more aggressively; otherwise, if the power adjustment is too slow, such method may not be effective enough to lower the temperature fast enough resulting in the temperature rising over the target temperature. In one novel aspect, the power limit is dynamically adjusted based on several factors, including the temperature jump and the temperature margin.

FIG. 2 illustrates an exemplary chart of power adjustment based on the temperature jump and temperature margin in accordance with embodiments of the current invention. A target temperature 211 is configured or predefined. Target temperate 211 is the upper temperature limit for the device to operate, and, thus, the temperature of the device is lower than the target temperate 211 or at least not to exceed the target temperate 211 too much. A trip temperature 212 is configured or predefined. Trip temperature 212 is smaller than the target temperature. When the current temperature of the device is higher the trip temperature, power adjustment actions are triggered. Line 201 is the current power setting adjusted based on the temperature in accordance with embodiments of the current invention. Line 202 is the temperature curve of the device.

During period 221, the current temperature is higher than the configured trip temperature. The temperature jump, which is the difference between the previous and the current temperature for a sampling period, is small. The temperature margin is large, which indicates that current temperature has a large distance to the target temperature. Based on the factors determined by the device, the power adjustment is triggered. The power is slightly adjusted at period 221 because the temperature jump is small and/or the temperature margin is large. In one embodiment, the temperature jump can be calculated over more than one sampling period. In another embodiment, the combination of range of the temperature jump and the temperature margin is considered in determining the power setting adjustment.

In contrast, during period 222, the temperature jump is large and the temperature margin is small. The device makes large power adjustment to lower the temperature fast. The steep power reduction at period 222 maintains the temperature below the target temperature. During period 223, the temperature jump is small. Although the temperature margin is small, due to the slight changes in the temperature, the power setting changes slightly.

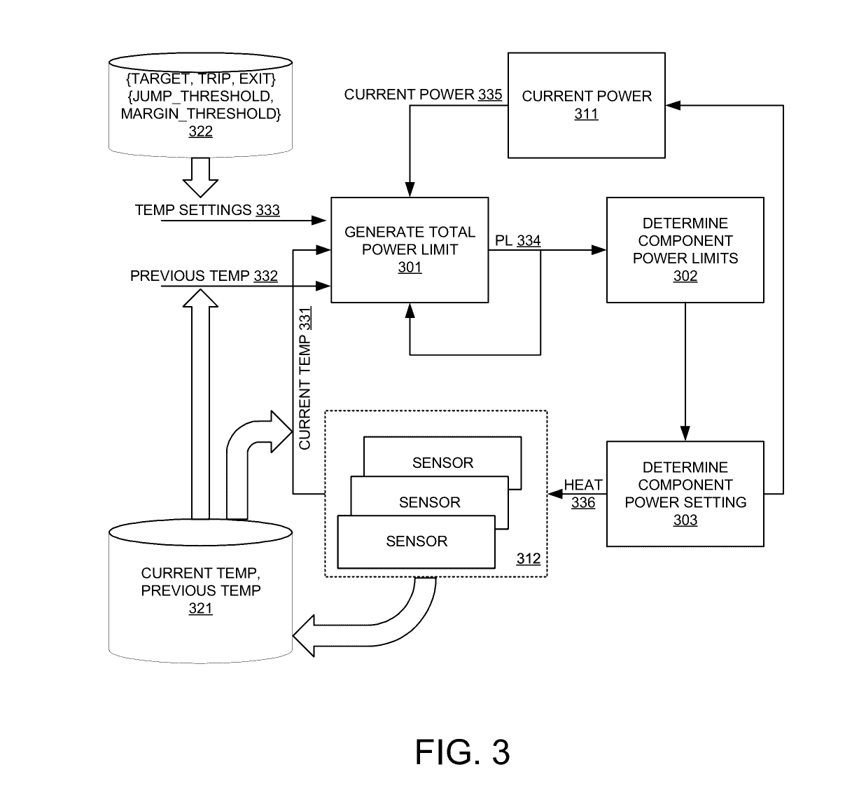

FIG. 3 shows an exemplary block diagram of adjusting the power setting based on multiple factors include the current temperature, the previous temperature and the target temperature in accordance with embodiments of the current invention. The device has multiple units/modules to adjust power settings to maintain the temperature within a target limit while enhancing the performance of the device. Module 301 generates the total power limit based on multiple inputs, including a current temperature 331, a previous temperature/temperature history 332, one or more temperature settings 333, a total power limit 334, a current power 335, or combination thereof. In one embodiment, module 301 gets current temperature 331 from one or more sensors 312. Module 301 gets previous temperature 332 from a database 321. In one embodiment, previous temperature 332 can be a temperature history, an average of one or more previous temperature readings, or other forms of indications of the previous temperature. Previous temperature 332 can be stored in memory or in a database internal or external to the device. Module 301 obtains one or more temperature settings from a database 322. The temperature settings include the target temperature, the trip temperature, the exit temperature, the temperature-jump threshold, temperature margin threshold, or any other temperature related setting. The temperature settings can be preconfigured or predefined. In one embodiment, part of the temperature settings or all the temperature settings can be maintained in combination of any methods including in memory, in internal or external databases. Module 301 outputs a total power limit 334 based on the multiple inputs. The total power limit 334 is feedback to module 301 as the previous total power limit.

A component power-limit (PL) module 302 determines one or more component power limits based on the output 334 from module 301. Component PL module 302 takes the total power limit and identifies each heating source/power source. Based on the total power limit, component PL module 302 determines a power limit for each power source such that the power is within the total power limit. Component PL module 302 outputs the component power limits to a component power-setting module 303. Component power-setting module 303 adjusts each power setting for each power source/component based on it corresponding power limit. The power setting of each component is sent to a current power module 311. Each component/heat source generates heat that may be detected by sensor 312. Temperature sensor 312 can be configured to obtain information representing different temperatures, such as die junction temperature, PCB temperature, DRAM temperature or device skin temperature. Current power setting 311 takes input from one or more components and outputs current power 335 to total PL module 301. In one embodiment, current power 335 can be obtained through one or combination of multiple methods including a power table lookup by Operation Performance Point (OPP) settings, a software power formula, or a hardware power meter.

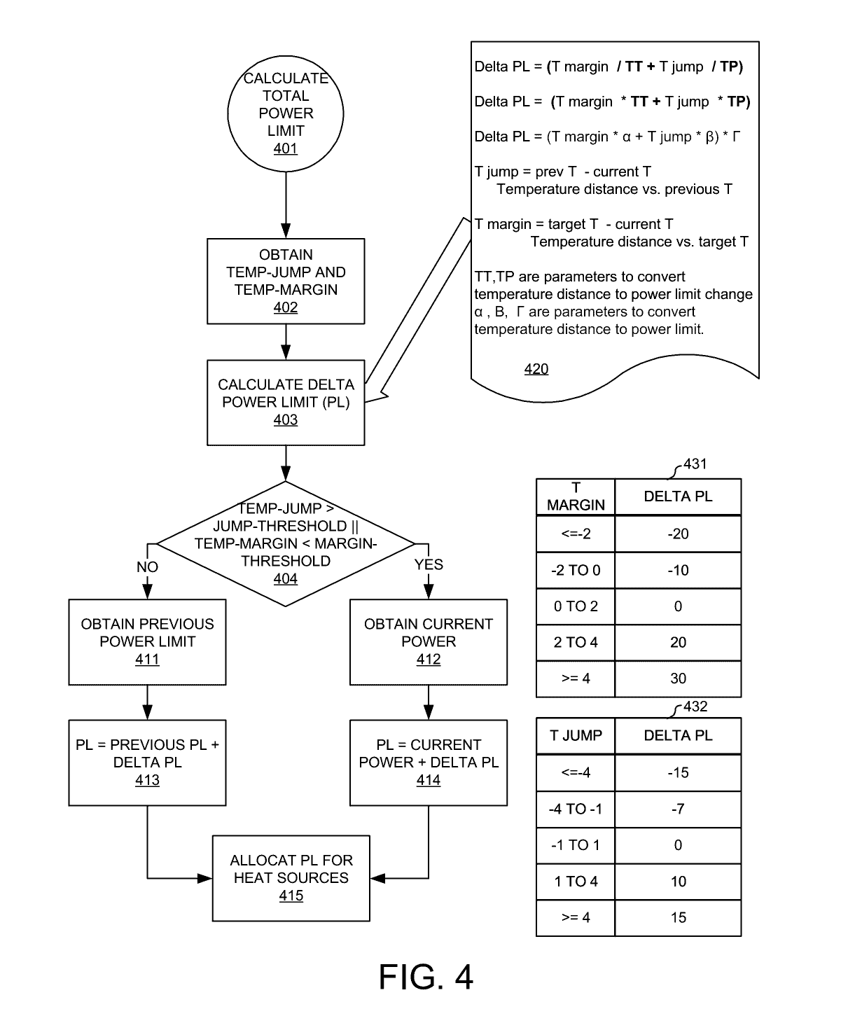

FIG. 4 shows an exemplary flow chart of generating a total power-limit based on multiple temperature inputs and temperature settings in accordance with embodiments of the current invention. Step 401 is the beginning of calculating the total power limit. In one embodiment, procedure 401 is triggered by one or more preconfigured or predefined conditions such as the current temperature is greater than a trip temperature, the current temperature is lower than an exit temperature, the temperature jump is greater than a temperature-jump threshold, or the temperature margin is smaller than a temperature-margin threshold. The total power limit equals to a base power plus a delta power limit. In some other embodiments, the total power limit may be set according to the base power and the delta power limit using other formula, which should not be limited in this disclosure. At step 402, the device obtains the value of the temperature jump and the temperature margin. In one embodiment, as shown in algorithm 420, the temperature jump equals the previous temperature minus the current temperature. The temperature margin equals to the target temperature minus the current temperature. The temperature jump and the temperature margin can be positive or negative. At step 403, the device calculates the delta power limit. The delta power limit is based on the temperature jump and the temperature margin. In one embodiment, the delta power limit is obtained by the weighted combination of the temperature jump and the temperature margin. The delta power limit equals to the temperature margin divided by a temperature-to-target-conversion (TT) plus the temperature margin divided by a temperature-previous-conversion (TP). TT and TP are parameters to convert temperature distance to power limit changes. TT and TP can be preconfigured and/or predefined. Other formula, as shown in 420 can be used to convert the temperature parameters to the power limit. For example, the delta power limit equals to the temperature margin times the TT plus the temperature margin times the TP. Other constant parameters can be used. For example, constants α, β, and γ are used for the conversion. The device obtains a first delta PL by calculating the sum of the temperature margin times α and the temperature margin times β. The delta power limit equals to the first delta PL times γ. In another embodiment, table look up can be used to obtain the delta power limit. Two exemplary tables 431 and 432 are shown in FIG. 4. DeltaPL table 431 converts temperature margin to a first PL(1). DeltaPL table 432 converts the temperature jump to a second PL(2). Upon obtaining PL(1) and PL(2) through the table lookup, the device obtains the delta power limit by calculating the sum of PL(1) and PL(2). Other methods can be used to obtain the delta power limit based on the temperature jump and the temperature margin.

The device needs to determine the base power based on the temperature condition. At step 404, the device determines if the temperature jump is greater than a temperature-jump threshold or the temperature margin is smaller than a temperature-margin threshold. If step 404 determines no, the device moves to step 411 and obtains a previous power limit. At step 413, the device generates the total power limit by adding the previous power limit to the delta power limit. In some other embodiments of step 413, the device generates the total power limit according to the previous power limit and the delta power limit, which should not be limited in this disclosure. If step 404 determines yes, the device moves to step 412 and obtains the current power. At step 414, the device generates the total power limit by adding the current power to the delta power limit. In some other embodiments of step 414, the device generates the total power limit according to the current power and the delta power limit, which should not be limited in this disclosure. The device upon obtaining the total power limit moves to step 415 and allocates one or more power limits for each heat sources based on the total power limit.

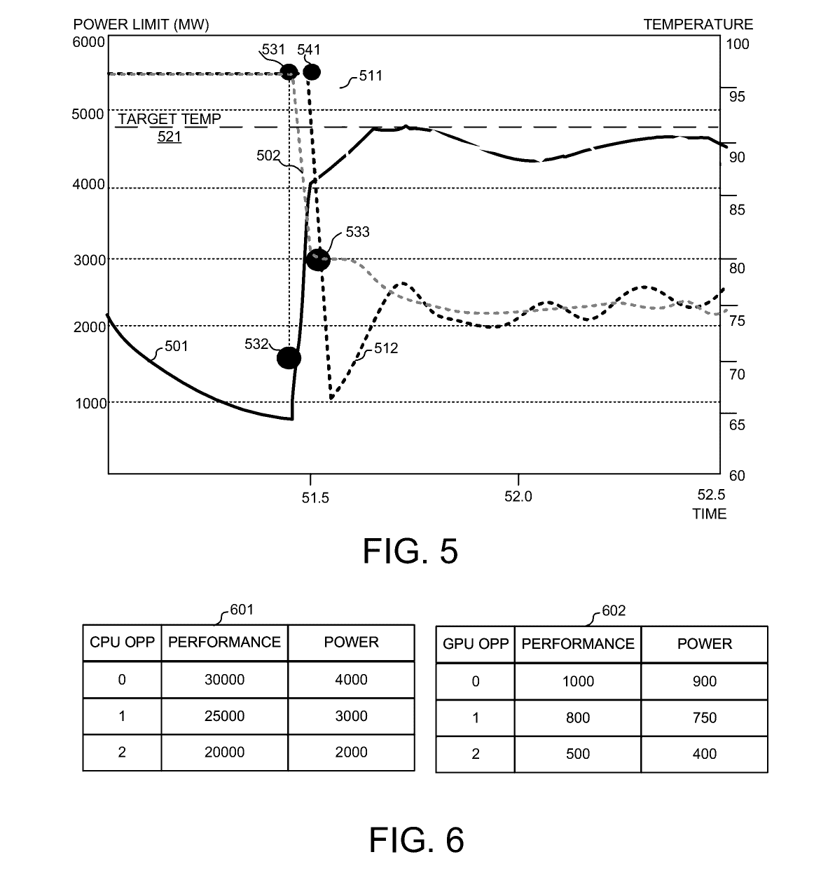

FIG. 5 illustrates comparison graphs of power adjustment based on traditional power throttling verses using the precious power budget methods in accordance with embodiments of the current invention. Graphs 501 and 502 are the temperature verses time and the power setting verses time, respectively, using the precious power budget in accordance with embodiment of the current invention. Graphs 511 and 512 are the temperature verses time and the power setting verses time, respectively, using the traditional thermal throttling. Line 521 is the target temperature line, which is the upper temperature limit for the device to operate normally.

As shown, the temperature graph and the power setting graph for both methods starts up the same. Following the traditional way, graph 512 does not start power reduction until point 541 when the current temperature is higher than the trip temperature. Since the temperature rises fast and the effectiveness of power reduction takes time, the temperature of the device continues to rise after the power reduction. As shown in graph 511, the temperature of the device rises over the target temperature even with steep power reduction. The device has to continue operates in much lower power setting for a longer period as shown in graph 512. Therefore, the traditional method causes large performance degradation while still risk the temperature rises to over the target temperature.

In contrast, by monitoring the multiple factors, such as the temperature jump and temperature margin, the power budget can be handled more efficiently while keeping the temperature below the target temperature. As the temperature starts to rise, at point 532, under the current invention, the device detects a large temperature jump. Although the current temperature is lower than the trip temperature and the temperature margin is smaller than the temperature-margin threshold, the large temperature jump triggers the power budget procedure. Therefore, at the same time of point 532, the device generates a new total power limit and adjusts the power setting accordingly at point 531. The power starts to drop. It takes time for the temperature to drop even after the power reduction. As shown in graph 501, the temperature continues to rise rapidly immediately after the power reduction. The temperature increase slows down after a while. At point 533, the temperature jump slows down and the temperature margin is not too small. As shown in graph 502, the power decrease slows down after point 533. As the temperature starts to stabilize, the power setting stabilized too. The temperature is kept at below the target temperature while maintaining the power setting at higher level to maximize the performance.

When generating the total power limit for the device, the device may need to get the current power value. There are multiple ways to get the current power. One of the methods is to use the power table lookup.

FIG. 6 illustrates exemplary power lookup table for different processors in accordance with embodiments of the current invention. The current power can be obtained through table lookup by OPP settings. In one embodiment, the device calculates a total power limit based on multiple inputs. Subsequently, component-level power limit is generated based on the total power limit. The power setting for each corresponding component can be adjusted individually. Table 601 is a lookup table by OPP for the CPU of the device. At OPP level 0, the performance is at 30000 with power of 4000. At OPP level 1, the performance is at 25000 with power of 3000. At OPP level 2, the performance is at 20000 with power of 2000. Table 602 is a lookup table by OPP for the GPU of the device. At OPP level 0, the performance is at 1000 with power of 900. At OPP level 1, the performance is at 800 with power of 750. At OPP level 2, the performance is at 500 with power of 400. Adjusting the OPP level for different chips/power sources in the device may result in different effectiveness for temperature change.

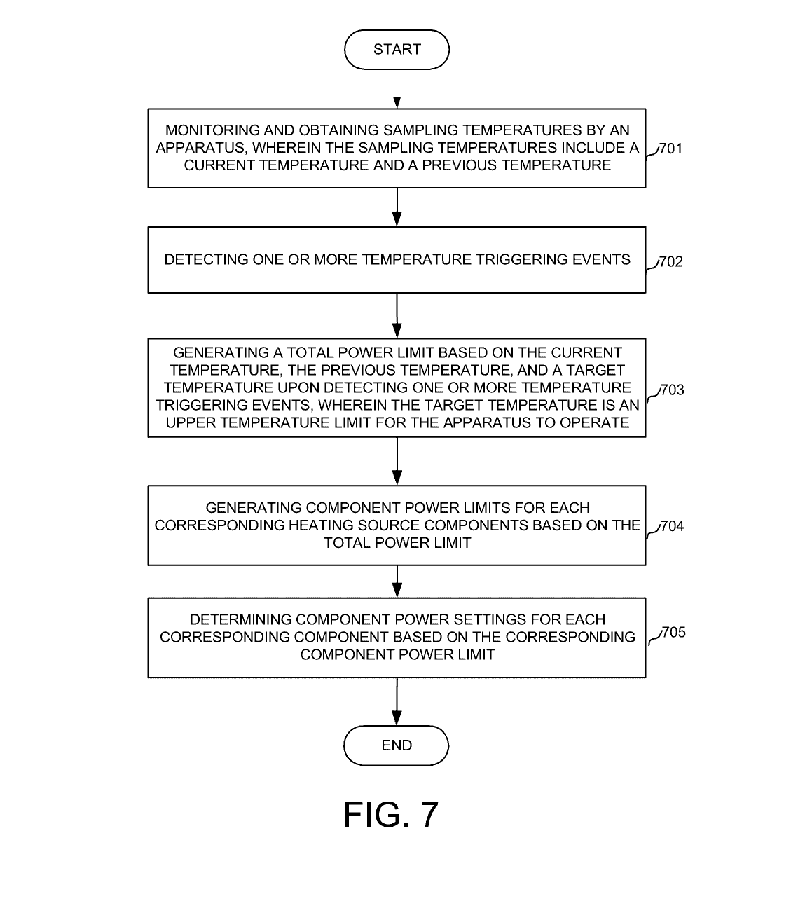

FIG. 7 shows an exemplary flow chart of the precious power budget procedure to enhance the performance in accordance with embodiments of the current invention. At step 701, the device monitors and obtains sampling temperatures, wherein the sampling temperatures include a current temperature and a previous temperature. At step 702, the device detects one or more temperature triggering events. At step 703, the device generates a total power limit based on the current temperature, the previous temperature, and a target temperature upon detecting one or more temperature triggering events, wherein the target temperature is an upper temperature limit for the apparatus to operate. At step 704, the device generates component power limits for each corresponding heating source components based on the total power limit. At step 705, the device determines component power settings for each corresponding component based on the corresponding component power limit.

In one novel aspect, the method for power allocation can be extended to resource allocation similarly. In one embodiment, the resource limit is adjusted based on the current resource setting, the current temperature, and the previous temperature.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
monitoring and obtaining sampling temperatures by an apparatus, wherein the sampling temperatures include a current temperature and a previous temperature;
detecting one or more temperature triggering events; and
generating a total power limit based on the current temperature, the previous temperature, and a target temperature upon detecting one or more temperature triggering events, wherein the target temperature is an upper temperature limit for the apparatus to operate.

2. The method of claim 1, wherein the temperature triggering events comprise: the current temperature is higher than a trip temperature and the current temperature is lower than an exit temperature.

3. The method of claim 2, wherein the trip temperature is greater than or equals to the exit temperature, and wherein the trip temperature and the exit temperature are both lower than the target temperature.

4. The method of claim 1, wherein the generating the total power limit involves: obtaining a base power and a delta power limit, wherein the total power limit equals to the sum of the base power and the delta power limit.

5. The method of claim 4, wherein obtaining the delta power limit involves:
obtaining a temperature jump and a temperature margin, wherein the temperature jump is the difference between the previous temperature and the current temperature and the temperature margin is the difference between the target temperature and the current temperature; and
calculating the delta power limit based on the temperature jump and the temperature margin.

6. The method of claim 5, wherein the delta power limit is reduced upon detecting one or more conditions comprising: the temperature jump is higher than a temperature-jump threshold, and the temperature margin is lower than a temperature-margin threshold.

7. The method of claim 4, wherein obtaining the base power involves: obtaining a current power and setting the base power to be the current power if the temperature jump is greater than a temperature-jump threshold or the temperature margin is smaller than a temperature-margin threshold, otherwise, setting the base power to be a previous power limit.

8. The method of claim 7, wherein the current power is obtained by one or combination of a plurality of means comprising: a power table lookup by Operation Performance Point (OPP) settings, a software power formula, and a hardware power meter.

9. The method of claim 1, further comprising:
identifying one or more heating source components;
generating component power limits for each corresponding heating source components based on the total power limit; and
determining component power settings for each corresponding component based on the corresponding component power limit.

10. The method of claim 9, wherein the heating sources comprises: processors, connectivity modules, modems, battery charging modules, and DRAMs.

11. An apparatus, comprising:
a trigger detector that detects one or more temperature triggering events; and
a total power limit unit that generates a total power limit based on a current temperature, a previous temperature, and a target temperature upon detecting one or more temperature triggering events, wherein the target temperature is an upper temperature limit for the apparatus to operate.

12. The apparatus of claim 11, wherein the temperature triggering events comprise: the current temperature is higher than a trip temperature and the current temperature is lower than an exit temperature.

13. The apparatus of claim 12, wherein the trip temperature is greater than or equals to the exit temperature, and wherein the trip temperature and the exit temperature are both lower than the target temperature.

14. The apparatus of claim 11, wherein the generating the total power limit involves: obtaining a base power and a delta power limit, wherein the total power limit equals to the sum of the base power and the delta power limit.

15. The apparatus of claim 14, wherein obtaining the delta power limit involves:
obtaining a temperature jump and a temperature margin, wherein the temperature jump is the difference between the previous temperature and the current temperature and the temperature margin is the difference between the target temperature and the current temperature; and
calculating the delta power limit based on the temperature jump and the temperature margin.

16. The apparatus of claim 15, wherein the delta power limit is reduced upon detecting one or more conditions comprising: the temperature jump is higher than a temperature-jump threshold, and the temperature margin is lower than a temperature-margin threshold.

17. The apparatus of claim 14, wherein obtaining the base power involves: obtaining a current power and setting the base power to be the current power if the temperature jump is greater than a temperature-jump threshold or the temperature margin is smaller than a temperature-margin threshold, otherwise, setting the base power to be a previous power limit.

18. The apparatus of claim 17, wherein the current power is obtained by one or combination of a plurality of means comprising: a power table lookup by Operation Performance Point (OPP) settings, a software power formula, and a hardware power meter.

19. The apparatus of claim 11, further comprising:
a heat source identifier that identifies one or more heating source components;
a component power limit unit that generates component power limits for each corresponding heating source components based on the total power limit; and
a component power setting unit that determines component power settings for each corresponding component based on the corresponding component power limit.

20. The apparatus of claim 19, wherein the heating sources comprises: processors, connectivity modules, modems, battery charging modules, and DRAMs.
